(19) United States
(12) Patent Application Publication
(10) Pub. No.: US 2015/0240419 A1
(43) Pub. Date: Aug. 27, 2015

(54) NOZZLE DEVICE

(71) Applicants: Hiroshi Sekiya, Tokyo (JP); Hideaki Mori, Fuji-shi (JP); Daisuke Kobayashi, Tokyo (JP)

(72) Inventors: Hiroshi Sekiya, Tokyo (JP); Hideaki Mori, Fuji-shi (JP); Daisuke Kobayashi, Tokyo (JP)

(21) Appl. No.: 14/423,010

(22) PCT Filed: Aug. 24, 2012
(86) PCT No.: PCT/JP2012/005337

§ 371 Date: Feb. 20, 2015

(51) Int. Cl. D21F 1/34; B05B 7/06; B05B 15/04

(52) U.S. Cl. CPC D21F 1/34; B05B 15/0431; B05B 7/068

(57) ABSTRACT

It is a subject to provide a nozzle device capable of effectively spraying air and capable of applying chemical solutions to a traveling body at a high deposition rate. For solving the subject, the present invention is a nozzle device 100 for applying a chemical solution Y to a traveling body 50 in a paper machine 101, the nozzle device 100 comprising a nozzle main body portion 2 having a chemical solution nozzle opening 1 capable of discharging the chemical solution Y, and an air main body portion 10 capable of spraying air from both sides of the nozzle main body portion 2 so as to put the discharged chemical solution Y between, wherein the air main body portion 10 includes an air introducing passage 13 for introducing air, a pair of front and rear flow passages 14 communicating with the air introducing passage 13 and a pair of air nozzle openings 12 communicating with each of the flow passages 14 for discharging air, and wherein a relationship between a cross-sectional area SA of the air introducing passage 13 and cross-sectional areas SB of the air nozzle openings 12 satisfies

SA≧SB.

### TECHNICAL FIELD

The present invention relates to a nozzle device, and more particularly to a nozzle device capable of effectively spraying air and capable of applying a chemical solution to a traveling body at a high deposition rate.

### BACKGROUND ART

In the paper industry, chemical solutions containing chemicals such as wet paper strengthening agents, washing materials, pitch control agents, antisoiling agents or parting agents are used for members of paper machines such as wires, felts, dryer rolls or canvases for the purpose of preventing transfer of foreign matters deriving from raw materials of pulp from paper bodies, or of improving separation of paper. Such chemical solutions are applied by using nozzle devices mounted to paper machines.

However, since the paper bodies move within the paper machines at high velocity in such paper machines, a flow of air is generated along movements thereof proximate of the surfaces of the paper bodies (hereinafter referred to as “accompanying flow”) so that phenomena are caused in that chemical solutions discharged towards the paper bodies by means of the nozzle devices are wound up by the accompanying flow.

In that case, not only is it impossible to sufficiently apply the chemical solutions to the paper bodies, but there are also caused cases in which the wound up chemical solutions adhere to frames or hoods to cause staining of the paper machines.

The inventors of the present invention have already suggested, as a nozzle device for preventing such winding up of chemical solutions, a nozzle device comprising a discharge nozzle capable of discharging a chemical solution, a first spraying nozzle positioned on an upstream side of the discharge nozzle and a second spraying nozzle positioned on a downstream side of the discharge nozzle, wherein a discharge angle of the chemical solution and spraying angles of the first spraying nozzle and the second spraying nozzle are defined (see Patent Literature 1).

They have also suggested a nozzle device comprising a nozzle main body, a first air main body and a second air main body, wherein the first air main body and the second air main body are provided with through holes which interior spaces are open to outside air (see Patent Literature 2). With such a nozzle device, it is possible to restrict the first and second air main bodies from being plugged by solid bodies.

### CITATION LIST

### Patent Literature

PTL 1: Japanese Patent Application Laid-Open No. 2008-18424
PTL 2: Japanese Patent Application Laid-Open No. 2008-290023

### SUMMARY OF INVENTION

### Technical Problem

However, while the above-mentioned nozzle devices recited in the Patent Literatures 1 and 2 allow application of chemical solutions to traveling bodies against accompanying flow, it cannot be necessarily said that the chemical solutions can be applied at high deposition rates.

Further, while it is possible to restrict solid bodies deriving from wound up chemical solutions from adhering to the air nozzles with time in the nozzle device recited in Patent Literature 2, such effects leave much to be desired. Namely, there is a drawback in that the efficiency of spraying air gradually decreases.

The present invention has been made in view of the above circumstances, and it is an object thereof to provide a nozzle device capable of effectively spraying air and capable of applying a chemical solution to a traveling body at a high deposition rate.

### Solution to Problems

In performing keen examinations for solving the above problem, the inventors of the present invention have found that in the conventional nozzle device, a periphery of progressing paths of air becomes a negative pressure when air is sprayed, and even though through holes are provided (see Patent Literature 2), a reverse flow of air is generated in the periphery of the progressing paths of air. They have further found that reverse flow of air can be surprisingly restricted by providing no through holes and by setting cross-sectional areas of nozzle openings and passages of air to satisfy a determined relationship, they and have come to complete the present invention.

The present invention resides (1) in a nozzle device for applying a chemical solution to a traveling body in a paper machine, the nozzle device comprising a nozzle main body portion having a chemical solution nozzle opening capable of discharging the chemical solution, and an air main body portion capable of spraying air from both sides of the nozzle main body portion so as to put the discharged chemical solution between, wherein the air main body portion includes an air introducing passage for introducing air, a pair of front and rear flow passages communicating with the air introducing passage and a pair of air nozzle openings communicating with each of the flow passages for discharging air, and wherein a relationship between a cross-sectional area SA of the air introducing passage and cross-sectional areas SB of the air nozzle openings satisfy

SA≧SB.

The present invention resides (2) in the nozzle device as recited in above (1) wherein the relationship of the cross-sectional area SA of the air introducing passage, minimum cross-sectional areas ST of the flow passages and the cross-sectional areas SB of the air nozzle openings satisfies

SA≧ST≧SB.

The present invention resides (3) in the nozzle device as recited in above (1) or (2) wherein the flow passages are provided with a large diameter portion for retaining air.

The present invention resides (4) in the nozzle device as recited in above (3) wherein the relationship of the cross-sectional area SA of the air introducing passage, the minimum cross-sectional areas ST of the flow passages, cross-sectional areas SD of the large diameter portions of the flow passages and the cross-sectional areas SB of the air nozzle openings satisfies

SD≧SA≧ST≧SB.

The present invention resides (5) in the nozzle device as recited in any one of above (1) to (4) wherein the chemical solution nozzle opening and the pair of air nozzle openings are aligned along a traveling direction of the traveling body, wherein the chemical solution nozzle opening is circular and the air nozzle openings are slit-like.

The present invention resides (6) in the nozzle device as recited in any one of above (1) to (5) wherein a pressure of air introduced to the air introducing passage is 0.02 to 0.3 MPa.

The present invention resides (7) in the nozzle device as recited in any one of above (1) to (6) wherein the traveling body is a paper body, a canvas, a dryer roll, a calendar roll or a canvas roll, and wherein the chemical solution includes wet paper strengthening agents, washing materials, pitch control agents, antisoiling agents or parting agents.

The present invention resides (8) in the nozzle device as recited in any one of above (1) to (7) wherein a scanning means is mounted to the paper machine, and wherein the scanning means performs reciprocating scanning.

### Advantageous Effects of Invention

In the nozzle device of the present invention, simultaneously with the discharge of a chemical solution from the chemical solution nozzle opening, air is sprayed from air nozzle openings on both sides of the chemical solution nozzle opening so that dispersion of the chemical solution through accompanying flow is restricted. Therefore, according to the above nozzle device, it is possible to reliably apply the chemical solution to the traveling body.

In the above nozzle device, the relationship between the cross-sectional area SA of the air introducing passage and the cross-sectional areas SB of the air nozzle openings is defined to satisfy SA≧SB whereby air can be sprayed from the entire air nozzle openings while maintaining the power of air. With this arrangement, reverse flow of air can be reliably prevented whereby it is made possible to effectively spray air and to apply the chemical solution to the traveling body at a high deposition rate.

Further, when the relationship of the cross-sectional area SA of the air introducing passage, the minimum cross-sectional areas ST of the flow passages and the cross-sectional areas SB of the air nozzle openings satisfies SA≧ST≧SB, air can be sprayed in an even more effective manner.

In the nozzle device of the present invention, when a large diameter portion for retaining air is provided in the flow passages, it is possible to apply the chemical solution to the traveling body at a higher deposition rate. At this time, it is more preferable that the relationship of the cross-sectional area SA of the air introducing passage, the minimum cross-sectional areas ST of the flow passages, the cross-sectional areas SD of the large diameter portions of the flow passages and the cross-sectional areas SB of the air nozzle openings satisfies SD≧SA≧ST≧SB.

In the nozzle device of the present invention, when the air nozzle openings are slit-like, air is sprayed in a form of a curtain. At this time, when the chemical solution nozzle opening is circular, the curtain-like air sprayed from the air nozzle openings can put the chemical solution discharged from the chemical solution nozzle opening between from both sides. It is accordingly possible to apply the chemical solution to the traveling body at a higher deposition rate.

In the nozzle device of the present invention, when it is arranged in that reciprocating scanning is performed by means of the scanning means, the chemical solution can be reliably applied to the traveling body even if there is only one nozzle device. In this respect, when there is only one nozzle device, maintenance thereof is made easy and it is also of advantage in view of costs.

### BRIEF DESCRIPTION OF DRAWINGS

FIG. 1 is a top view showing a nozzle device according to the present embodiment, and FIG. 1(b) is a side view showing the nozzle device according to the present embodiment.

FIG. 2 is a schematic view showing a state in which a chemical solution and air are sprayed to a traveling body from the nozzle device according to the present embodiment.

FIG. 3 is a cross-sectional view along line A-A of the nozzle device shown in FIG. 1(a).

FIG. 4 is a cross-sectional view along line B-B of the nozzle device shown in FIG. 1(b).

FIG. 5(a) is an explanatory view for explaining an air spraying state, in case air is made to flow from passages having a large cross-sectional area to passages having a small cross-sectional area like in the nozzle device of the present invention, and FIG. 5(b) is an explanatory view for explaining an air spraying state, in case air is made to flow from passages having a small cross-sectional area to passages having a large cross-sectional area.

FIG. 6 is a perspective view schematically showing an example in which the nozzle device according to the present embodiment is used in a paper machine.

FIG. 7 is a perspective view schematically showing another example in which the nozzle device according to the present embodiment is used in a paper machine.

FIG. 8 is a top view schematically showing another example in which the nozzle device according to the present embodiment is used in a paper machine.

FIG. 9 is a view for explaining a method of testing deposition rates of examples and comparative examples.

FIG. 10 is a photo of a nozzle main body portion of the nozzle device of Example 3 of Evaluation 2.

FIG. 11 is a photo of a nozzle main body portion of the nozzle device of Comparative Example 1 of Evaluation 2.

### DESCRIPTION OF EMBODIMENTS

Favorable embodiments of the present invention will be explained in details hereinbelow with reference to drawings as necessary. In this respect, identical elements are marked with identical reference signs, and duplicated explanations will be omitted. Further, unless specified otherwise, positional relationships of top and bottom or right and left are based on the positional relationships as shown in the drawings. Moreover, dimensional ratios of the drawings are not limited to the illustrated ratios.

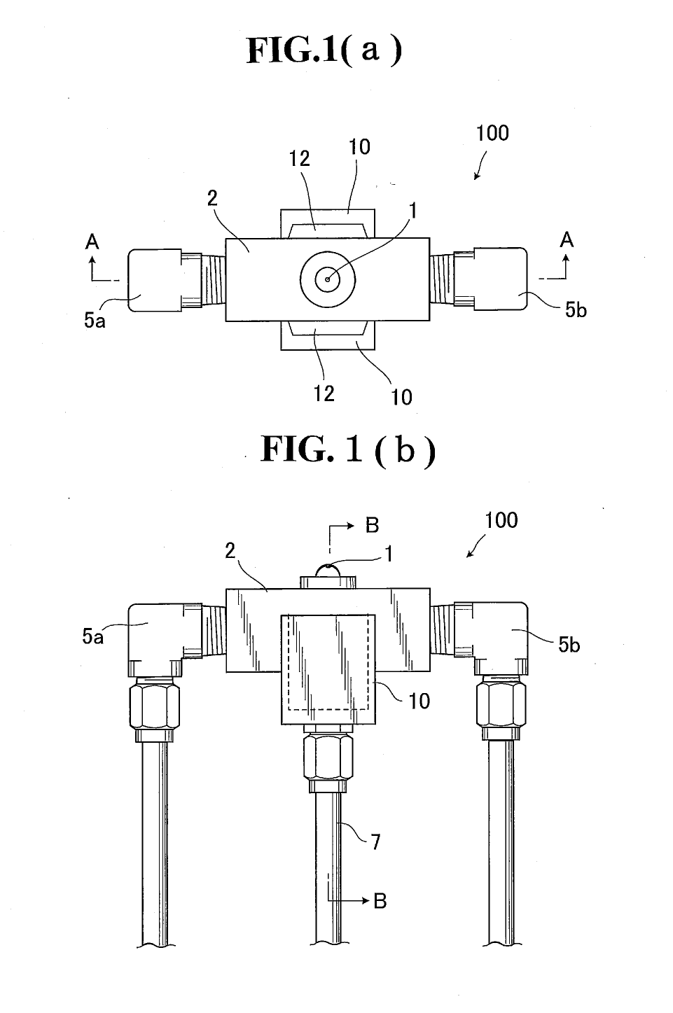

FIG. 1(a) is a top view showing a nozzle device according to the present embodiment, and FIG. 1(b) is a side view showing the nozzle device according to the present embodiment.

As shown in FIG. 1(a) and FIG. 1(b), a nozzle device 100 according to the present embodiment comprises a nozzle main body portion 2 including a chemical solution nozzle opening 1 capable of discharging a chemical solution; an air main body portion 10 including air nozzle openings 12 capable of spraying air from both sides of the nozzle main body portion 2 so as to put the discharged chemical solution between; and a tube 7 connected to the air main body portion 10 for introducing air to an air introducing passage.

In the nozzle device 100, simultaneously with the discharge of a chemical solution from the chemical solution nozzle opening 1, air is sprayed from the air nozzle openings 12 on both sides of the chemical solution nozzle opening 1 so that dispersion of the chemical solution through accompanying flow is restricted.

Here, the chemical solution nozzle opening 1 is circular and the air nozzle openings 12 are slit-like. With this arrangement, sprayed air will have a form of a curtain so as to put the chemical solution discharged from the chemical solution nozzle opening between from both sides.

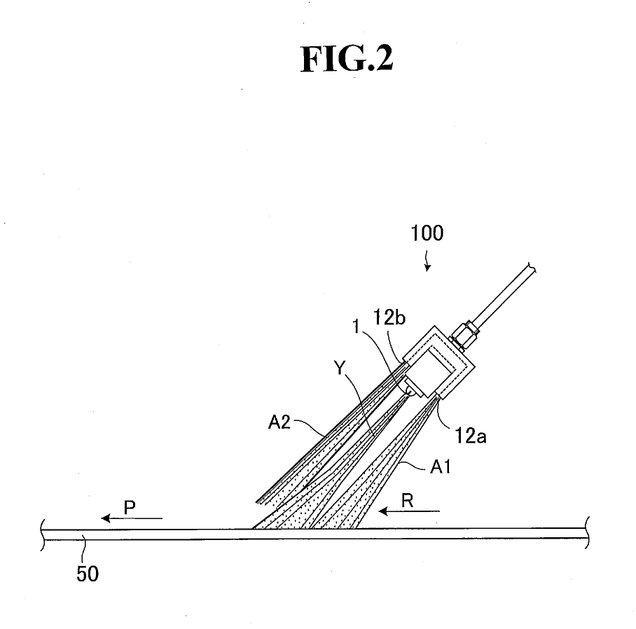

FIG. 2 is a schematic view showing a state in which a chemical solution and air are sprayed to a traveling body from the nozzle device according to the present embodiment.

As shown in FIG. 2, for restricting dispersion of the chemical solution by means of the accompanying flow R, the nozzle device 100 is disposed at an acute angle with respect to a traveling direction of the traveling body 50. Namely, the nozzle device 100 is arranged to discharge the chemical solution towards a downstream side of the traveling body 50.

The nozzle device 100 is arranged in that the chemical solution nozzle opening 1 and the pair of air nozzle openings 12 are aligned in a linear manner along the traveling direction P of the traveling body 50. Namely, the air nozzle opening (hereinafter also referred to as “upstream side air nozzle opening” for the sake of convenience) 12a, the chemical solution nozzle opening 1 and the air nozzle opening (hereinafter also referred to as “downstream side air nozzle opening” for the sake of convenience) 12b are aligned in this order from the upstream side of the traveling body 50. In this respect, the upstream side air nozzle opening 12a and the downstream side air nozzle opening 12b are identical in structure.

In the nozzle device 100, a part of the accompanying flow R is shielded since air A1 sprayed from the upstream side air nozzle opening 12a is sprayed towards the upstream side of the chemical solution Y (accompanying flow R side which is generated by the traveling of the traveling body 50).

Further, winding up of the chemical solution Y by the accompanying flow R is restricted since air A2 sprayed from the downstream side air nozzle opening 12b is sprayed towards the downstream side of the chemical solution Y.

With this arrangement, it is possible to reliably apply the chemical solution Y to the traveling body 50 against the accompanying flow R, in case the traveling body 50 also travels at a high velocity.

Returning to FIG. 1(a) and FIG. 1(b), in the nozzle device 100, the nozzle main body 2 has a rectangular parallelepiped shape, and the chemical solution nozzle opening 1 is provided at a substantially center on a top surface thereof.

Arm portions 5a, 5b are connected to both sides of the nozzle main body portion 2 for fixing the nozzle main body portion 2. Supply pipes for sending the chemical solution to the nozzle main body portion 2 and the chemical solution nozzle opening 1 are provided in the interior of the arm portions 5a, 5b. In this respect, the supply pipes will be described later.

In the nozzle device 100, the air main body portion 10 has a sectional shape in form of the letter U and it can be attached from below the nozzle main body portion 2 so as to put the nozzle main body portion 2 between. Namely, the nozzle main body portion 2 is detachable.

Further, the upstream side air nozzle opening 12a and the downstream side air nozzle opening 12b are formed by assembling the air main body portion 10 to the nozzle main body portion 2, and by supplying air from the air introducing passage, air of equal strength is sprayed from the upstream side air nozzle opening 12a and the downstream side air nozzle opening 12b.

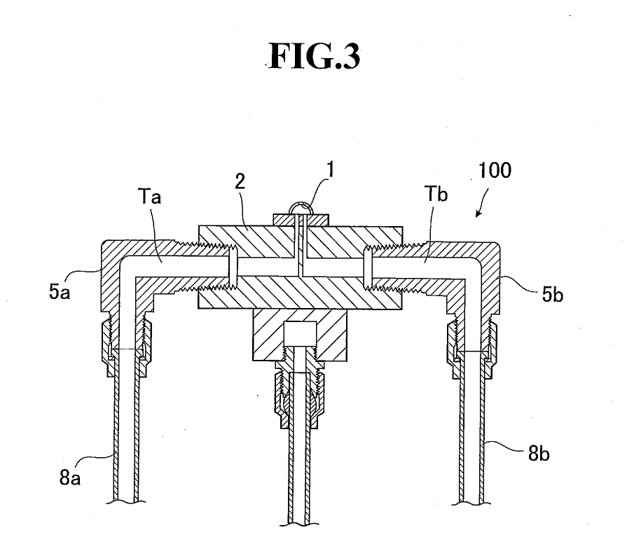

FIG. 3 is a cross-sectional view along line A-A of the nozzle device shown in FIG. 1(a).

As shown in FIG. 3, at the nozzle main body portion 2 of the nozzle device 100, a chemical solution supply pipe 8a for supplying the chemical solution to the nozzle main body portion 2 is connected to the arm portion 5a while a discharge air supply pipe 8b for supplying air for discharging the chemical solution is connected to the arm portion 5b.

Further, a chemical solution passage Ta is formed in the interior of the arm portion 5a while a discharge air passage Tb is formed in the interior of the arm portion 5b.

In the nozzle device 100, the chemical solution supplied from the chemical solution supply pipe 8a flows through the interior of the chemical solution supply pipe 8a and is sent to the chemical solution passage Ta communicating with the chemical solution supply pipe 8a. The chemical solution is then sent from the chemical solution passage Ta to the nozzle main body portion 2.

On the other hand, air supplied from the discharge air supply pipe 8b flows through the interior of the discharge air supply pipe 8b and is sent to the discharge air passage Tb communicating with the discharge air supply pipe 8b. The air is then sent from the discharge air passage Tb to the nozzle main body portion 2.

A mixture of the chemical solution and air sent to the nozzle main body portion 2 is discharged from the chemical solution nozzle opening 1. In other words, in the nozzle device 100, since air is supplied simultaneously with supplying the chemical solution to the chemical solution nozzle opening 1, the chemical solution is discharged together with air. At this time, the discharged chemical solution is accelerated by the power of discharged air.

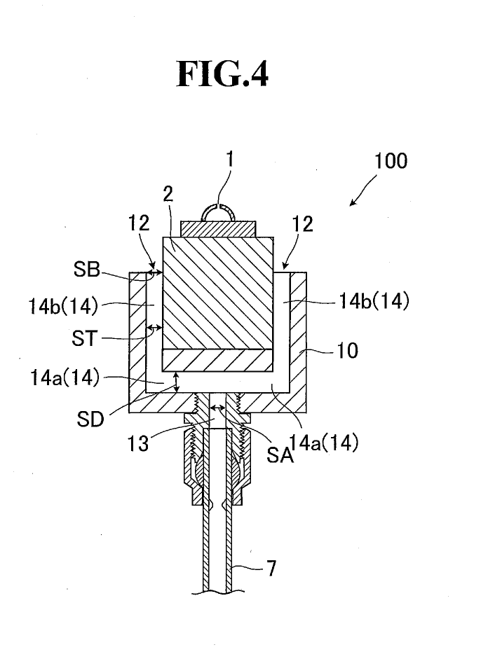

FIG. 4 is a cross-sectional view along line B-B of the nozzle device shown in FIG. 1(b).

As shown in FIG. 4, in the nozzle device 100, the air main body portion 10 includes an air introducing passage 13 for introducing air, a pair of front and rear flow passages 14 communicating with the air introducing passage 13 and a pair of air nozzle openings 12 communicating with each of the flow passages 14 for discharging air.

Each flow passage 14 is constituted of a large diameter portion 14a communicating with the air introducing passage 13 in a bent manner and a small diameter portion 14b communicating with the large diameter portion 14a in a bent manner. In this respect, the small diameter portion 14b has a minimum cross-sectional area in the flow passage 14.

In the nozzle device 100, air is introduced from the tube 7 to the air introducing passage 13.

The introduced air is branched to an upstream side and a downstream side in the interior of the air main body portion 10, passes through the respective large diameter portions 14a and small diameter portions 14b and is sprayed to the traveling body from the air nozzle openings 12.

In the nozzle device 100, the relationship between a cross-sectional area SA of the air introducing passage 13 and cross-sectional areas SB of the air nozzle openings 12 satisfies

SA≧SB.

Therefore, the air pressure is not attenuated in the nozzle device 100, and it is possible to spray from the entire air nozzle openings 12 while maintaining the air pressure of the air introducing passage 13.

With this arrangement, since the periphery of the progressing passage of air will not become a negative pressure, reverse flow of air is reliably prevented, and it is consequently possible to spray air in an effective manner and to apply the chemical solution Y to the traveling body 50 at a high deposition rate.

It is also desirable that the relationship of the cross-sectional area SA of the air introducing passage 13, the minimum cross-sectional areas (cross-sectional areas of the small diameter portions 14b) ST of the flow passages 14 and the cross-sectional areas SB of the air nozzle openings 12 satisfies

SA≧ST≧SB.

Since the power of air is not restricted in this case, it is possible to spray air in an effective manner.

Here, since the flow passages 14 comprise the large diameter portions 14a in the nozzle device 100, it is possible to sufficiently retain air. In this case, the amount of discharged air will increase so that it is possible to apply the chemical solution to the traveling body at a higher deposition rate.

At this time, it is more preferable that the relationship of the cross-sectional area SA of the air introducing passage 13, the minimum cross-sectional areas ST of the flow passages 14, the cross-sectional areas SD of the large diameter portions 14a of the flow passages 14 and the cross-sectional areas SB of the air nozzle openings 12 satisfies

SD≧SA≧ST≧SB.

Namely, in the nozzle device 100, it is preferable to arrange the entire passages of air such that the cross-sectional area becomes smaller the more they come closer to the downstream side and to provide the large diameter portions 14a only in the flow passages 14.

A mechanism with which a periphery of a progressing passage of air becomes a negative pressure when air flows from a passage of large cross-section to a passage of small cross-section will now be explained.

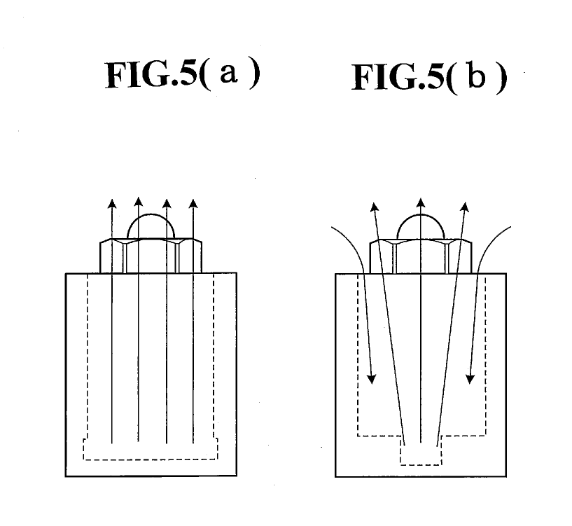

FIG. 5(a) is an explanatory view for explaining an air spraying state, in case air is made to flow from passages having a large cross-sectional area to passages having a small cross-sectional area like in the nozzle device of the present invention, and FIG. 5(b) is an explanatory view for explaining an air spraying state, in case air is made to flow from passages having a small cross-sectional area to passages having a large cross-sectional area.

As shown in FIG. 5(b), in case air flows from passages of small cross-section to passages of large cross-section, no air pressure will be applied to the periphery of the progressing passages of air but the periphery of the progressing passages of air will conversely become a negative pressure due to Venturi effect. In this case, a reverse flow of air is generated in the periphery of the progressing passages of air so that it might, for instance, happen that solid bodies deriving from wound up chemical solutions adhere to the air nozzles with time.

In contrast thereto, as shown in FIG. 5(a), in case air flows from passages of large cross-section to passages of small cross-section, air will progress over the entire passage and the periphery of the progressing passages of air will not become a negative pressure. With this arrangement, reverse flow of air is reliably prevented, and it is consequently possible to spray air in an effective manner and to apply the chemical solution Y to the traveling body 50 at a high deposition rate in the nozzle device 100.

In the nozzle device 100 according to the present embodiment, it is preferable that the pressure of air flowing through the discharge air supply pipe 8b is 0.04 to 0.15 MPa. In this case, it will be possible to discharge the chemical solution in an effective and reliable manner.

Further, the pressure of air introduced to the air introducing passage 13 is preferably 0.02 to 0.3 MPa.

When the pressure of air introduced to the air introducing passage 13 is less than 0.02 MPa, accompanying flow cannot be sufficiently shielded when compared to cases in which the pressure of air introduced into the air introducing passage 13 is within the above-described range so that the wound up chemical solution cannot be sufficiently suppressed.

On the other hand, when the pressure of air introduced to the air introducing passage 13 exceeds 0.3 MPa, the sprayed air itself will be a turbulent flow when compared to cases in which the pressure of air introduced into the air introducing passage 13 is within the above-described range, and it tends to hinder adhesion of the chemical solution to the traveling body 50.

In the nozzle device 100, it is preferable that a distance from the tip of the chemical solution nozzle opening 1 to an intersection of the discharge direction of the chemical solution Y and the traveling body 50 is 30 mm to 120 mm. In this case, it will be possible to reliably apply the chemical solution to the traveling body 50 while sufficiently restricting dispersion of the chemical solution also in a paper machine of ultrahigh speed.

The nozzle device 100 according to the present embodiment is used for applying the chemical solution Y to the traveling body 50 in a paper machine.

The traveling body 50 might, for instance, be a paper body, a wire, a felt, a canvas, a dryer roll, a calendar roll or a canvas roll.

Among these, the nozzle device 100 is preferably used for a paper body, a canvas, a dryer roll, a calendar roll or a canvas roll. Since a paper body, a canvas, a dryer roll, a calendar roll or a canvas roll generally travels at high velocity in a paper machine and stains, pitches or loosening of the paper or the like are easily generated which can be effectively prevented.

The chemical solution Y might, for instance, be a wet paper strengthening agent, a washing material, a pitch control agent, an antisoiling agent or a parting agent.

Since it is possible to reliably apply the chemical solution Y to the traveling body 50 with the nozzle device 100, the traveling body 50 applied with the chemical solution Y can reliably exhibit functions deriving from the applied chemical solution Y.

In this respect, the viscosity of the chemical solution Y is preferably not more than 500 cps, and more preferably 1 cps to 200 cps. In this case, it is possible to reliably apply the chemical solution Y to the traveling body 50 and to sufficiently restrict dispersion of the chemical solution.

In the nozzle device 100 according to the present embodiment, the chemical solution Y and air are supplied from a pump unit (not shown). In this respect, a cross-section of a pipe through which air is supplied from the pump unit is preferably not less than the cross-sectional area SC of the tube 7.

Next, a method for applying a chemical solution using the nozzle device 100 according to the present embodiment will be explained.

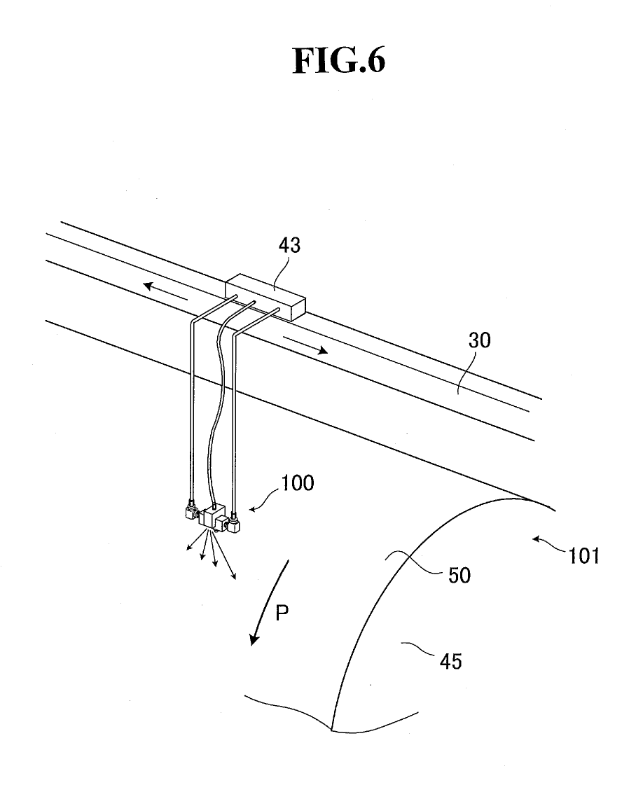

FIG. 6 is a perspective view schematically showing an example in which the nozzle device according to the present embodiment is used in a paper machine.

As shown in FIG. 6, a paper machine 101 includes a rotatable drum 45, and the traveling body 50 is disposed in the drum 45. With the rotation of the drum 45, the traveling body 50 is made to travel in a traveling direction P.

In the paper machine 101, there is provided a scanning means 30 upward of the drum 45. A driving device 43 performing reciprocating scanning in the length direction of the scanning means 30 is mounted to the scanning means 30, and the nozzle device 100 is mounted to the driving device 43 such that it can discharge the chemical solution to the traveling body 50. In this respect, the nozzle device 100 is mounted upon adjusting an angle between the traveling direction P of the traveling body 50 and a discharging direction of the chemical solution Y such that the discharged chemical solution Y is sufficiently applied to the traveling body 50.

The nozzle device 100 is then made to perform reciprocating scanning with the driving device 43 while making the traveling body 50 travel in the traveling direction P, and the chemical solution is discharged from the nozzle device 100 to the traveling body 50 so as to apply the chemical solution Y to the traveling body 50.

At this time, the chemical solution is applied from the chemical solution nozzle opening 1 of the nozzle device 100 while air is sprayed from the air nozzle openings 12.

Since the nozzle device 100 is used in the above method for applying the chemical solution, it is possible to restrict cases in which the air nozzle openings 12 are plugged by solid bodies.

Further, since air is sprayed from the air nozzle openings 12 simultaneously with the application of the chemical solution Y from the chemical solution nozzle opening 1, it is possible to reliably apply the chemical solution Y to the traveling body 50 and to sufficiently restrict dispersion of the chemical solution Y also in the paper machine 101 of ultrahigh speed.

In the above method for applying the chemical solution, since the scanning means 30 is mounted to the paper machine 101 and the nozzle device 100 is made to perform reciprocating scanning by means of the scanning means 30, it is possible to reliably apply the chemical solution Y to the traveling body 50, in case only one nozzle device 100 also is provided. In this respect, when there is only one nozzle device 100, maintenance thereof is made easy and it is also of advantage in view of costs.

While a preferred embodiment of the present invention has been explained so far, the present invention is not to be limited to the above embodiment.

While the chemical solution nozzle opening 1 is circular in the nozzle device 100 of the present embodiment, it might also be slit-like or ring-like.

While the chemical solution nozzle opening 1 and the air nozzle openings 12 are aligned in a linear manner with respect to the traveling direction P in the nozzle device 100 of the present embodiment, they need not necessarily be aligned in a linear manner.

While the nozzle main body portion 2 and the air main body portion 10 are provided separately in the nozzle device 100 of the present embodiment, they might also be integrated.

The nozzle device 100 of the present embodiment might also be used for food processing or textile processing in addition to its use in a paper machine.

While one nozzle device 100 is mounted to the paper machine 101 in the above-described example in which the nozzle device 100 according to the present embodiment is used in the paper machine 101, it is also possible to mount a plurality of nozzle devices 100 to the paper machine.

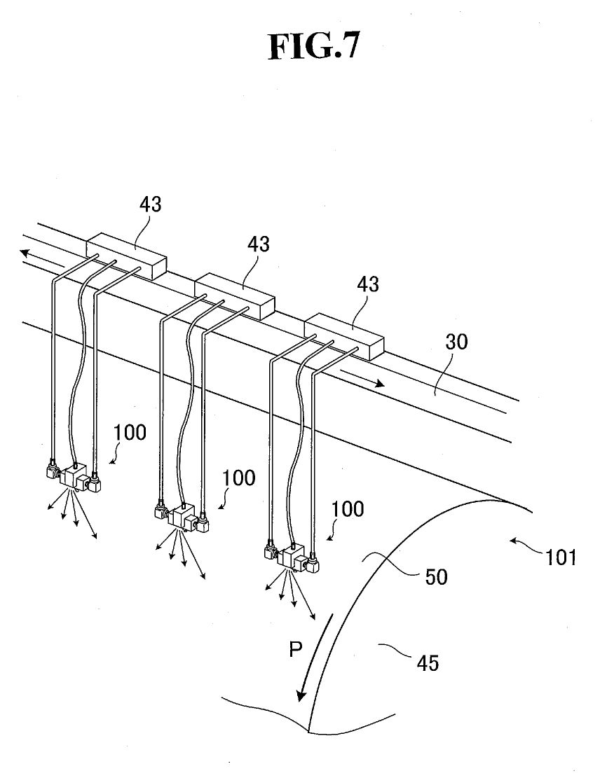

FIG. 7 is a perspective view schematically showing another example in which the nozzle device according to the present embodiment is used in a paper machine.

As shown in FIG. 7, it is possible that in a paper machine, a scanning means 30 is mounted with a plurality of driving devices 43 performing reciprocating scanning in the length direction of the scanning means 30, wherein a nozzle device 100 is mounted to each of the driving devices 43 such that a chemical solution is discharged to a traveling body 50.

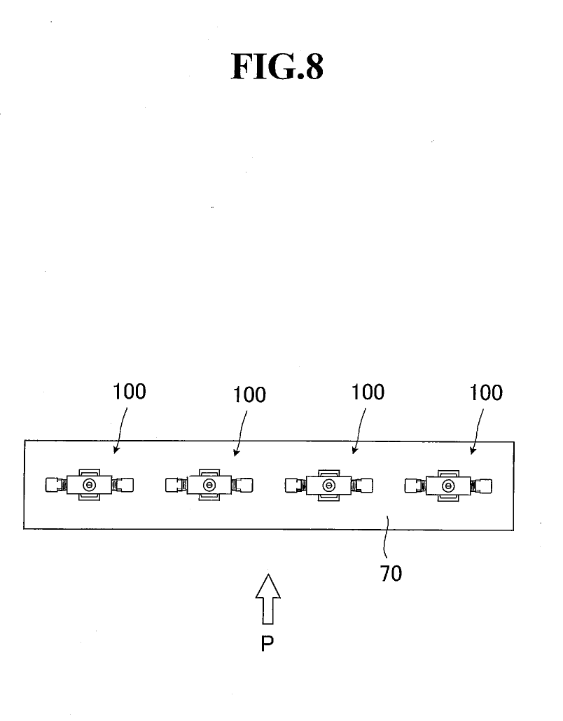

FIG. 8 is a top view schematically showing another example in which the nozzle device according to the present embodiment is used in a paper machine.

As shown in FIG. 8, it is possible to mount a plurality of nozzle devices 100 to a predetermined main body 70. Namely, when this is used in a paper machine, a chemical solution is discharged simultaneously from the plurality of nozzle devices 100 mounted to the main body 70 so that there is no need to perform reciprocating scanning of the nozzle device 100.

In this respect, the main body 70 incorporates therein a tube, a chemical solution supply pipe and a discharge air supply pipe (not shown). Further, a traveling body (not shown) travels in a traveling direction P (traveling direction).

### EXAMPLES

While examples using the nozzle device of the present invention will be specifically explained, the present invention is not to be limited to these.

### Examples 1 to 10 and Comparative Example 1

Nozzle devices which the cross-sectional areas SA of the air introducing passages, the cross-sectional areas SD of the large diameter portions of the flow passages, the cross-sectional areas ST of the small diameter portions of the flow passages and the cross-sectional areas SB of the air nozzle openings shown in FIG. 4 have been adjusted to the values indicated in Table 1 were provided. In this respect, in Examples 8 to 10, the cross-sections of the large diameter portions were set to be smaller than the cross-sections of the small diameter portions. Namely, the large diameter portions were made to function as the small diameter portions while the small diameter portions were made to function as the large diameter portions.

TABLE 1

| | SA (mm²) | SD (mm²) | ST (mm²) | SB (mm²) |
|---|---|---|---|---|
| Example 1 | 28.3 | 120.0 | 13.0 | 13.0 |
| Example 2 | 28.3 | 85.0 | 18.0 | 13.0 |
| Example 3 | 28.3 | 85.0 | 13.0 | 13.0 |
| Example 4 | 28.3 | 85.0 | 5.0 | 13.0 |
| Example 5 | 28.3 | 19.6 | 5.0 | 5.0 |
| Example 6 | 28.3 | 19.6 | 7.0 | 7.0 |
| Example 7 | 28.3 | 13.0 | 13.0 | 13.0 |
| Example 8 | 28.3 | 13.0 | 85.0 | 13.0 |
| Example 9 | 28.3 | 9.6 | 13.0 | 13.0 |
| Example 10 | 28.3 | 7.0 | 13.0 | 13.0 |
| Comparative | 15.9 | 44.0 | 0.3 | 28.8 |
| Example 1 | | | | |

### <Evaluation 1>

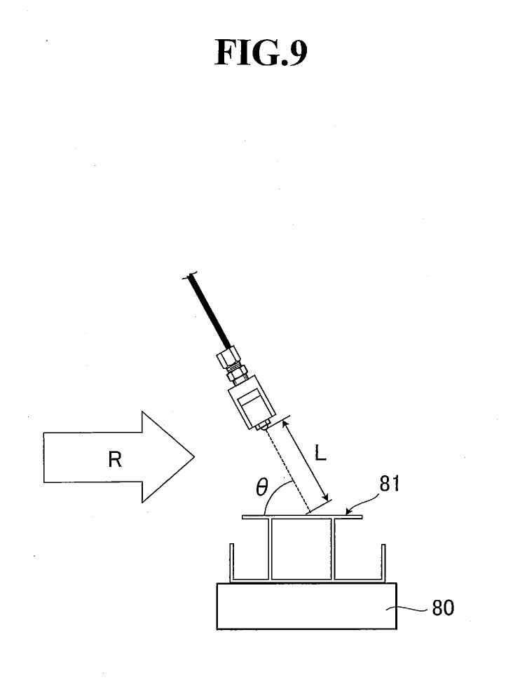

As shown in FIG. 9, each nozzle device obtained in Examples 1 to 10 and Comparative Example 1 was disposed to face down such that the air nozzle openings assumed a predetermined angle θ; a SUS plate 81 was disposed downward of the nozzle device and a scale 80 below the SUS plate 81 such that a disseminating distance L with respect to the nozzle device was 10 cm.

DusClean R409S (parting agent, viscosity 3 cps, manufactured by Maintech Co. Ltd.) was used as a chemical solution, wind of 3.0 m/s was sprayed from a side surface instead of accompanying flow R; the chemical solution was sprayed for one minute while setting the pressure of air flowing through the discharge air supply pipe 8b to 0.1 MPa; and simultaneously therewith, air was sprayed for one minute while setting the pressure of air to 0.3 MPa.

The deposition rate (amount of chemical solution adhering to the SUS plate 81×100/amount of discharged chemical solution) was measured based on the amount of chemical solution adhering to the SUS plate 81 and the amount of discharged chemical solution.

The obtained results are shown in Table 2.

TABLE 2

| | Deposition rate (%) |
|---|---|
| Example 1 | 84 |
| Example 2 | 84 |
| Example 3 | 84 |
| Example 4 | 61 |
| Example 5 | 69 |
| Example 6 | 73 |
| Example 7 | 77 |
| Example 8 | 84 |
| Example 9 | 61 |
| Example 10 | 59 |
| Comparative | 41 |
| Example 1 | |

From the results of Table 2, it was confirmed that it was possible to adhere the chemical solution to the traveling body at a sufficiently high deposition rate in the Examples 1 to 10 using the nozzle device according to the present invention when compared to the Comparative Example 1 which is not based on the present invention. Particularly Examples 1, 2, 3 and 8 satisfying

SD≧SA≧ST≧SB

exhibited extremely superior deposition rates.

### <Evaluation 2>

The nozzle devices of Example 3 and Comparative Example 1 were used, DusClean R409S (parting agent, viscosity 3 cps, manufactured by Maintech Co. Ltd.) was used as a chemical solution, wind of 3.0 m/s was sprayed from a side surface instead of accompanying flow R; the chemical solution was sprayed for two weeks while setting the pressure of air flowing through the discharge air supply pipe 8b to 0.1 MPa; and simultaneously therewith, air was sprayed for two weeks while setting the pressure of air to 0.3 MPa.

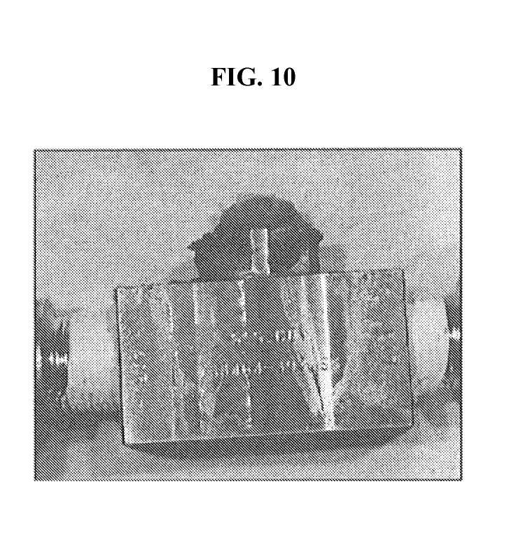

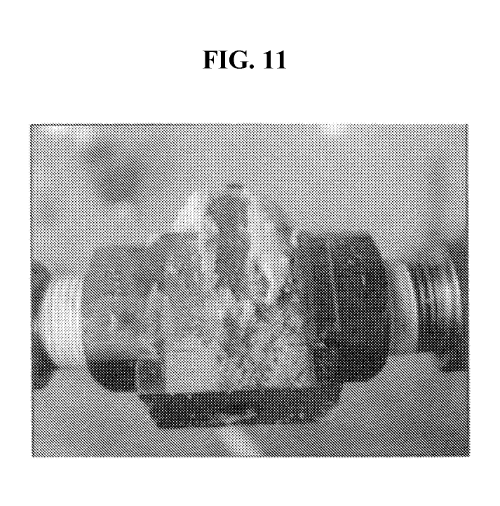

Photos of the nozzle devices after two weeks are shown in FIG. 10 and FIG. 11. In this respect, FIG. 10 is a photo of a nozzle main body portion of the nozzle device of Example 3 of Evaluation 2. Further, FIG. 11 is a photo of a nozzle main body portion of the nozzle device of Comparative Example 1 of Evaluation 2.

It can be said from FIG. 10 and FIG. 11 that since the amount of adhesion of solid bodies to the nozzle main body portion is less in Example 3 using the nozzle device according to the present invention when compared to Comparative Example 1 which is not based on the present invention, the spraying force of air has remarkably been improved so that it is possible to effectively spray air.

From the above results, it has been confirmed that it is possible spray air in an effective manner and to make the chemical solution adhere to the traveling body at a high deposition rate with the nozzle device of the present invention.

### INDUSTRIAL APPLICABILITY

The nozzle device 72 according to the present invention is favorably used as a device for applying a chemical solution to a traveling body in a paper machine. It is possible spray air in an effective manner and to make the chemical solution adhere to the traveling body at a high deposition rate with the nozzle device of the present invention.

### REFERENCE SIGNS LIST

1 . . . chemical solution nozzle opening
2 . . . nozzle main body
5a, 5b . . . arm portion
7 . . . tube
8a . . . chemical solution supply pipe
8b . . . discharge air supply pipe
10 . . . air main body portion
12 . . . air nozzle opening
12a . . . upstream side air nozzle opening (air nozzle opening)
12b . . . downstream side air nozzle opening (air nozzle opening)
13 . . . air introducing passage
14 . . . flow passage
14a . . . large diameter portion
14b . . . small diameter portion
30 . . . scanning means
43 . . . driving device
45 . . . drum
50 . . . traveling body
70 . . . main body
80 . . . scale
81 . . . SUS plate
100 . . . nozzle device
10l . . . paper machine
A1, A2 . . . air
L . . . disseminating distance
P . . . traveling direction
R . . . accompanying flow
SD . . . cross-sectional area of large diameter portion
ST . . . cross-sectional area of small diameter portion
SA . . . cross-sectional area of air introducing passage
SB . . . cross-sectional area of air nozzle opening
SC . . . cross-sectional area of tube
Ta . . . chemical solution passage
Tb . . . discharge air passage
Y . . . chemical solution

1. A nozzle device for applying a chemical solution to a traveling body in a paper machine, the nozzle device, comprising:
a nozzle main body portion having a chemical solution nozzle opening capable of discharging the chemical solution, and
an air main body portion capable of spraying air from both sides of the nozzle main body portion so as to put the discharged chemical solution between,
wherein the air main body portion includes an air introducing passage for introducing air, a pair of front and rear flow passages communicating with the air introducing passage and a pair of air nozzle openings communicating with each of the flow passages for discharging air, and
wherein a relationship between a cross-sectional area SA of the air introducing passage and cross-sectional areas SB of the air nozzle openings satisfies
SA≧SB.

2. The nozzle device according to claim 1,
wherein the relationship of the cross-sectional area SA of the air introducing passage, minimum cross-sectional areas ST of the flow passages and the cross-sectional areas SB of the air nozzle openings satisfies
SA≧ST≧SB.

3. The nozzle device according to claim 1,
wherein the flow passages are provided with a large diameter portion for retaining air.

4. The nozzle device according to claim 3,
wherein the relationship of the cross-sectional area SA of the air introducing passage, the minimum cross-sectional areas ST of the flow passages, cross-sectional areas SD of the large diameter portions of the flow passages and the cross-sectional areas SB of the air nozzle openings satisfies
SD≧SA≧ST≧SB.

5. The nozzle device according to claim 1,
wherein the chemical solution nozzle opening and the pair of air nozzle openings are aligned along a traveling direction of the traveling body, and
wherein the chemical solution nozzle openings are circular and the air nozzle openings are slit-like.

6. The nozzle device according to claim 1,
wherein a pressure of air introduced to the air introducing passage is 0.02 to 0.3 MPa.

7. The nozzle device according to claim 1,
wherein the traveling body is a paper body, a canvas, a dryer roll, a calendar roll or a canvas roll, and
wherein the chemical solution includes wet paper strengthening agents, washing materials, pitch control agents, antisoiling agents or parting agents.

8. The nozzle device according to claim 1,
wherein a scanning means is mounted to the paper machine, and
wherein the scanning means performs reciprocating scanning.
